(19) United States
(12) Patent Application Publication
(10) Pub. No.: US 2010/0036891 A1
(43) Pub. Date: Feb. 11, 2010

(54) APPARATUS AND METHOD FOR COLLECTING LOGGING INFORMATION, AND COMPUTER-READABLE RECORDING MEDIUM IN WHICH A LOGGING INFORMATION COLLECTING PROGRAM IS STORED

(75) Inventor: Kozo MATSUSHITA, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/479,264

(22) Filed: Jun. 5, 2009

(30) Foreign Application Priority Data
Aug. 6, 2008 (JP) 2008-202496

(51) Int. Cl. G06F 17/30

(52) U.S. Cl. 707/200; 707/E17.005

(57) ABSTRACT

An apparatus for collecting logging information in relation to a log function inserted into a program, the apparatus includes: a control table retaining control information in relation to specification information to specify the log function; an obtaining section obtaining the specification information embedded in the log function when the log function is executed; a judging section judging, on the basis of the control information in the control table and the specification information obtained by the obtaining section, whether or not the logging information associated with the specification information is to be collected; and a storage controller storing, if the result of the judging by the judging section is positive, the logging information into a memory, the specification information including position information of the log function in the program.

### CROSS-REFERENCE TO RELATED APPLICATIONS

This application is based upon and claims the benefit of priority of the prior Japanese Patent Application No. 2008-202496, filed on Aug. 6, 2008, the entire contents of which are incorporated herein by reference.

### FIELD

The embodiment discussed herein is technology suitable for collecting logging information associated with a logging function inserted into a program.

### BACKGROUND

There has generally been known a technique to collect logging information relative to a logging function inserted to a program to check a possible failure occurred in a system.

For example, during the execution of the program, execution of a logging function that has previously inserted into a program causes the computer to store logging information associated with the logging information being executed into a storage device such as a memory. Thereby, in the event of occurrence of a failure in the system, the system manager can check the failure with reference to the logging information stored in the memory device.

For example, it is known that trace functions to call trace information is inserted into trace points on a program and that a piece of trace point information unique to each trace function to specify the point of the trace function is embedded into the trace function. In this technique, a program running trance acquisition device collects trace function executed while the program is executed and trace information associated with the trace function in which trace point information assigned by the operator is embedded is selectively collected and stored into a storage device such as a memory. Thereby, it is possible to surely provide only trace information that the operator considers to be required for diagnosing the cause of the failure.

[Patent Reference 1] Japanese Patent Application Laid-Open (KOKAI) No. HEI 11-161515

However, the above technique needs to manage unique information for instructions to select as to whether trace information is to be collected, so that it is extremely difficult to manage a vast amount of unique information.

Therefore, the above technique causes no problem when being applied to a relatively small project such as a private use, but makes it extremely difficult to instruct the selection as to whether or not trance information associated with each of the large number of trace functions are to be collected if applied to a large-scale project or an open source.

### SUMMARY

According to an aspect of the embodiment, there is provided an apparatus for collecting logging information in relation to a log function inserted into a program, the apparatus including: a control table retaining control information in relation to specification information to specify the log function; an obtaining section obtaining the specification information embedded in the log function when the log function is executed; a judging section judging, on the basis of the control information retained in the control table and the specification information obtained by the obtaining section, whether or not the logging information associated with the specification information is to be collected; and a storage controller storing, if the result of the judging by the judging section is positive, the logging information into a memory, the specification information including position information of the log function in the program.

According to another aspect of the embodiment, there is provided a method for collecting logging information in relation to a log function inserted into a program, the method including: (a) obtaining specification information embedded in the log function when the log function is executed; (b) judging, on the basis of control information in relation to the specification information retained in a control table and the specification information obtained in the step (a) of obtaining, whether or not the logging information associated with the specification information is to be collected; and (c) storing, if the result of the step (b) of judging is positive, the logging information into a memory, the specification information including position information of the log function in the program.

According an additional aspect of the embodiment, there is provided a computer-readable recording medium in which a logging information collecting program for collecting logging information in relation to a log function inserted into a program, the logging information collecting program instructing a computer to function as: an obtaining section obtaining specification information embedded in the log function when the log function is executed; a judging section judging, on the basis of control information in relation to the specification information retained in a control table and the specification information obtained by the obtaining section, whether or not the logging information associated with the specification information is to be collected; and a storage controller storing, if the result of the judging by the judging section is positive, the logging information into a memory, the specification information including position information of the log function in the program.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram schematically illustrating an example of the configuration of an apparatus for collecting logging information according to a first embodiment;

FIG. 2 is a diagram denoting an example of description of a log function L′ used in an apparatus for collecting logging information of the first embodiment;

FIG. 3 is a diagram depicting an example of the notation of a logging control table of an apparatus for collecting logging information of the first embodiment;

FIG. 4 is a diagram denoting an example of command information inputted into an apparatus for collecting logging information of the first embodiment;

FIG. 5 is a flow diagram depicting a succession of procedural steps performed to create a program that is to be used in an apparatus for collecting logging information of the first embodiment;

FIG. 6 is a flow diagram depicting a succession of procedural steps performed to instruct to start logging in an apparatus for collecting logging information of the first embodiment;

FIGS. 7 and 8 are flow diagrams depicting a succession procedural steps performed to collect logging information in an apparatus for collecting logging information of the first embodiment; and

FIG. 9 is a flow diagram depicting a succession of procedural steps performed to update a logging control table in an apparatus for collecting logging information of the first embodiment.

### DESCRIPTION OF EMBODIMENT(S)

Hereinafter, description will now be made in relation to embodiments of the invention.

### (1) First Embodiment

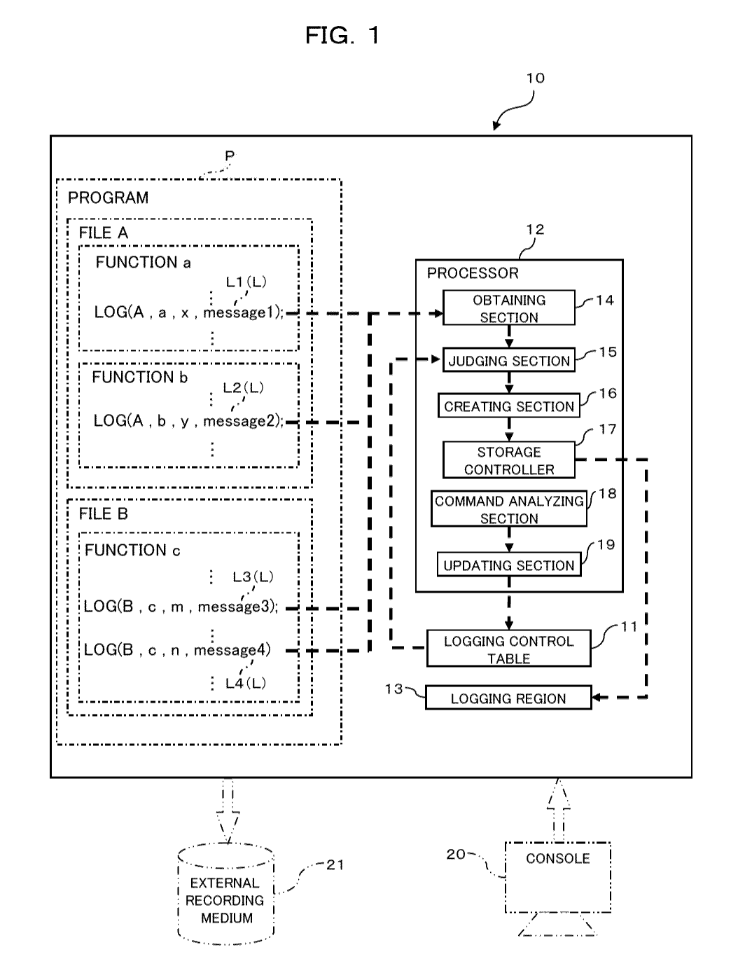

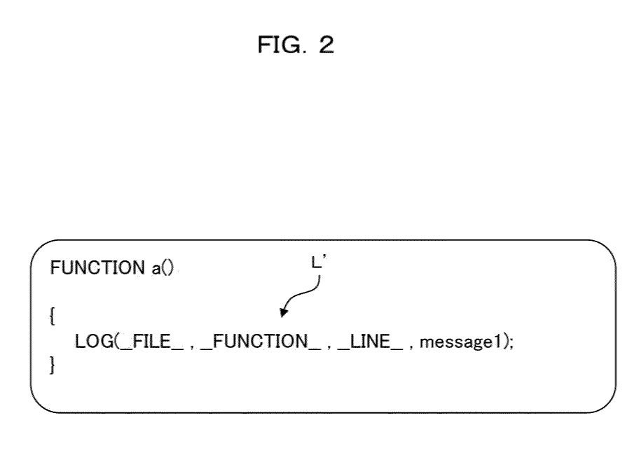

FIG. 1 schematically illustrates an example of the configuration of an apparatus 10 for collecting logging information according to a first embodiment, and FIG. 2 denotes an example of the notation of a log function L′ used in the apparatus 10 for collecting logging information.

The apparatus 10 for collecting logging information of the first embodiment collects logging information (not illustrated) in relation to a logging function (logging control function) L inserted into a program P. The apparatus 10 for collecting logging information explicitly calls a logging collecting process, for example, each time the log function L is executed during the execution of the program P.

Here, the program P is a program code to accomplish predetermined operations in the apparatus 10 for collecting logging information, and includes, for example, a file A and a file B, as depicted in FIG. 1. The file A includes a function a and a function b, and the file B includes a function c.

In the program P, the log function L is inserted. In the example of FIG. 1, a log function L1 is inserted in the function a; a log function L2 is inserted in the function b; and a log function L3 and a log function L4 are inserted in the function c.

Hereinafter, the log functions are discriminated from one another by reference numbers L1-L4 if required, but an arbitrary log function is represented by a reference symbol L.

A log function L is a LOG function to call a logging collecting process that is to be detailed below, and specification information and a message are embedded in the log function L.

Specification information specifies a log function L in the program P and has position information representing the position of the log function at the program. In the first embodiment, specification information is formed of a first argument, a second argument, and a third argument. Accordingly, a log function L in the first embodiment is represented by, for example, LOG (first argument, second argument, third argument, message).

A first argument represents the file name of a file in which a log function L is inserted on the program P.

In the example of FIG. 1, the log function L1 is inserted in the file A and therefore the first argument of the log function L1 is “A” representing the file name of the file A. Similarly, the first argument of the log function L2 is “A” representing the file name of the file A, and the first arguments of the log functions L3 and L4 are “B” representing the file name of the file B.

A second argument represents the function name of a function in which a log function L is inserted on a file.

In the example of FIG. 1, the log function L1 is inserted in the function a, and therefore the second argument of the log function L1 is “a” representing the function name of the function a. Similarly, the second argument of the log function L2 is “b” representing the function name of the function b, and the second arguments of the log functions L3 and L4 are “c” representing the function name of the function c.

A third argument represents the line number of a log function in a function.

In the example of FIG. 1, the log function L1 is inserted on the x-th line of the function a and therefore the third argument of the log function L1 is “x” representing the line number of the log function a. Similarly, the third argument of the log function L2 is “y” representing the line number of the log function L2 in the function b; the third argument of the log function L3 is “m” representing the line number of the log function L3 in the function c; and the third argument of the log function L4 is “n” representing the line number of the log function L4 in the function c.

A message is information that is to be used in creating of logging information, and can be, for example, any value or any letter string described by the program creator.

In the example of FIG. 1, a “message 1” is inserted in the log function L1. Similarly, a “message 2” is inserted in the log function L2; a “message 3” is inserted in the log function L3; and a “message 4” is insert into the log function L4.

A log function L is abstractedly described by the program creator when the program is created. For example, if a log function L′ abstractedly described as denoted in FIG. 2 to be compilable by a GNU (GNU is Not Unix) compiler is inserted into the program P, a tool of the GNU compiler replaces such abstracted description, representing the file name, the function name, the line number and others, in the log function L′ with a log function L in which the file name, the function name, the line number and others are represented by specific values and the automatically creates code when compiling.

The apparatus 10 for collecting logging information is a computer including, as illustrated in FIG. 1, a logging control table (control table) 11, a processor 12, and a logging region (memory) 13.

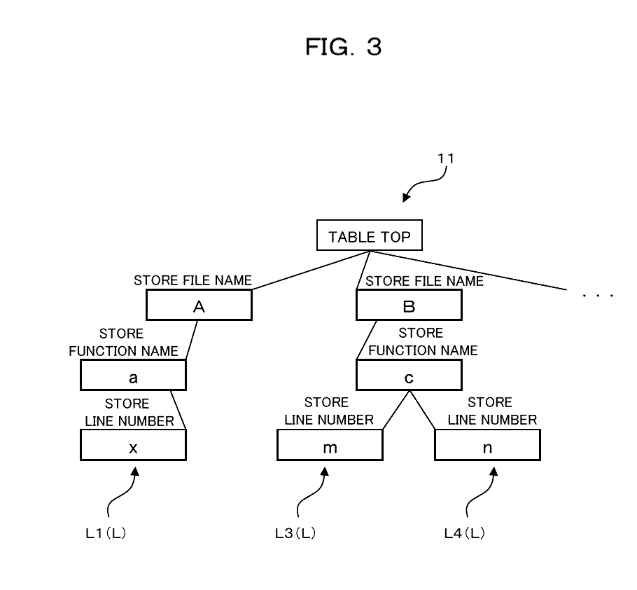

FIG. 3 schematically illustrates an example of the configuration of the logging control table 11 of the apparatus 10 for collecting logging information of the first embodiment.

The logging control table 11 registers therein (retains) control information representing a position of logging for logging information that is to be collected in response to a command from a console 20 (see FIG. 1) that is to be described below, and is realized by, for example, a storage device such as a memory. The logging control table 11 hierarchically registers therein control information corresponding to specification information associated with logging information that is to be collected. Namely, the logging control table 11 retains control information in relation to specification information.

Specifically, the logging control table 11 retains first control information, second control information and third control information respectively representing a first argument, a second argument, and a third argument that are embedded in a log function associated with logging information that is to be collected in the form of being registered into a tree shape in which the first control information (on the top layer) through the third control information (on the bottom layer) are hierarchically associated with one another. Accordingly, in the first embodiment, first control information represents a file name similarly to a first argument; second control information represents a function name similarly to a second argument; and third control information represents line number similarly to a third argument. In other words, the logging control table 11 registers therein a tree shape having sections of file name (first control information), function name (second control information), and line number (third control information).

In the example of FIG. 3, the logging control table 11 retains the file name “A”, the function name “a”, and the line number “x” respectively representing first control information, second control information, and third control information, in a tree shape. That registers logging information associated with the log function L1 into the logging control table 11 to serve as logging information that is to be collected.

Further, the logging control table 11 retains the file name “B”, the function name “c”, and the line numbers “m” and “n” respectively representing first control information, second control information, and third control information, in a tree shape so that logging information associated with the log functions L3 and L4 is registered into the logging control table 11 to serve as logging information that is to be collected.

The processor 12 carries out in the apparatus 10 for collecting logging information a logging collecting process and is realized by a processing unit such as a Central Processing Unit (CPU). The processor 12 functions as, for example, an obtaining section 14, a judging section 15, a creating section 16, a storage controller 17, a command analyzing section 18, and an updating section 19.

The obtaining section 14 obtains a log function L each time the log function L is executed during the execution of the program P.

Specifically, when a log function L is executed during the execution of the program P, a logging collecting process is called. The obtaining section 14 obtains the log function L executed and also specification information (the first argument, the second argument, and the third argument) embedded in the log function L. In other words, the obtaining section 14 receives the specification information passed from the log function L.

The judging section 15 judges, on the basis of control information retained in the logging control table 11 and specification information obtained by the obtaining section 14, whether or not the logging information associated with the obtained specification information is to be collected (a logging controlling process).

Specifically, after the obtaining section 14 has obtained the first, the second, and the third arguments, the judging section 15 searches the tree shape of the table from the top (top layer; see FIG. 3) to the bottom in order of first control information (file name), second control information (function name), and third control information (line number). Then the judging section 15 judges the logging information which is associated with the log function L and which has been obtained by the obtaining section 14 to be collected when all the below requirements (1) to (3) are satisfied.
(1) the first argument obtained by the obtaining section 14 matches one of first control information pieces registered in the logging control table 11;
(2) the second argument obtained by the obtaining section 14 matches one of second control information pieces registered in the logging control table 11; and
(3) the third argument obtained by the obtaining section 14 matches one of third control information pieces registered in the logging control table 11.

Therefore, if specification information obtained by the obtaining section 14 is included in the control information retained in the logging control table 11, the judging section 15 judges the logging information associated with the obtained specification information is to be collected.

In the first embodiment, when the obtaining section 14 obtains the first argument “A”, the second argument “a” and the third argument “x” of the log function L1, the judging section 15 judges the logging information associated with the log function L1 to be collected because the three arguments obtained by the obtaining section 14 have already been registered in the logging control table 11.

If the obtaining section 14 obtains the first argument “A”, the second argument “b” and the third argument “y” of the log function L2, the judging section 15 judges the logging information associated with the log function L2 not to be collected because the second argument “b” and the third argument “y” have not been registered in the logging control table 11.

If the obtaining section 14 obtains the first argument “B”, the second argument “c” and the third argument “m” of the log function L3, the judging section 15 judges the logging information associated with the log function L3 to be collected because the three arguments obtained by the obtaining section 14 have already been registered in the logging control table 11.

If the obtaining section 14 obtains the first argument “B”, the second argument “c” and the third argument “n” of the log function L4, the judging section 15 judges the logging information associated with the log function L4 to be collected because the three arguments obtained by the obtaining section 14 have already been registered in the logging control table 11.

The creating section 16 creates, on the basis of the log function obtained by the obtaining section 14, logging information that has been judged by the judging section 15 to be collected. In other words, the creating section 16 creates logging information judged by the judging section 15 to be collected which logging information is included in pieces of logging information obtained by the obtaining section 14 and is associated with the log function L. For example, the logging information includes the message embedded in the log function L, and, if required, specification information. The creation of logging information can be accomplished by any known method.

The storage controller 17 controls storage of logging information judged by the judging section 15 to be collected into a logging region that is to be described below. In the first embodiment, the storage controller 17 carries out control so that logging information created by the creating section 16 is stored into the logging region 13.

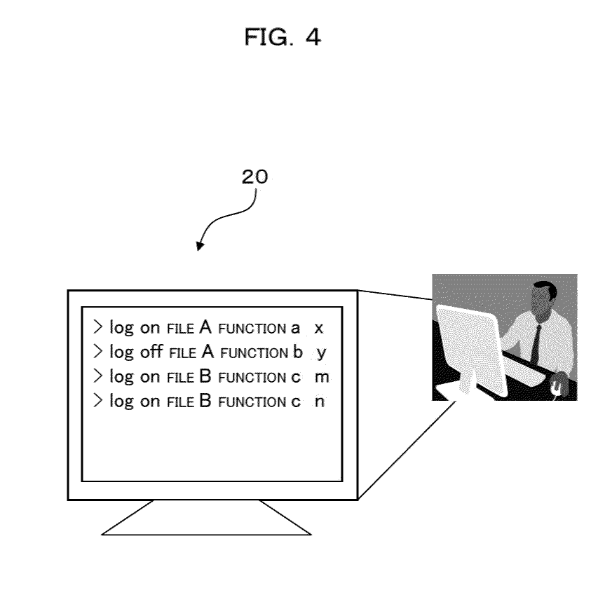

FIG. 4 illustrates an example of an input of command information issued to the apparatus 10 for collecting logging information of the first embodiment.

The command analyzing section 18 analyzes command information (a command) sent from the external console 20 (in other words, carries out command analysis) and thereby creates a table updating function.

A table updating function is used for performing an updating process on the logging control table 11. Here, an updating process represents addition and deletion of control information (entries) to and from the logging control table 11.

For example, the operator that intends to instruct the start of logging by the log function L1 inputs into the console 20 command information including the file name “A”, the function name “a”, and the line number “x” in addition to information “log on” representing a logging start command, as depicted in FIG. 4. Upon receipt of command information input into the console 20, the command analyzing section 18 creates, on the basis of the received command information, a table updating function to determine logging information corresponding to the log function L1 to be collected. Specifically, the command analyzing section 18 creates a table updating function for a logging start command including first to third control information. Here, the first control information corresponds to the first argument embedded in the log function L1, that is, the file name “A”; the second control information corresponds to the second argument embedded in the log function L1, that is, the function name “a”; and the third control information corresponds to the third argument embedded in the log function L1, that is, the line number “x”.

The start of logging by the log functions L3 and L4 is instructed in the same manner as the above instruction of the start of logging by the log function L1 (see FIG. 4).

For example, the operator that intends to terminate logging by the log function L2 inputs into the console 20 command information including the file name “A”, the function name “b”, and the line number “y” in addition to information “log off” representing a logging termination command, as depicted in FIG. 4. Upon receipt of the command information input into the console 20, the command analyzing section 18 creates, on the basis of the received command information, a table updating function to exclude the logging information corresponding to the log function L2 from logging information to be collected. Specifically, the command analyzing section 18 creates a table updating function for a logging termination command including first to third control information associated with the first to the third arguments embedded in the log function L2. Here, the first control information corresponds to the first argument embedded in the log function L2, that is, the file name “A”; the second control information corresponds to the second argument embedded in the log function L2, that is, the function name “b”; and the third control information corresponds to the third argument embedded in the log function L2, that is, the line number “y”.

The updating section 19 carries out an updating process on the logging control table 11 with the use of a table updating function created by the command analyzing section 18.

Specifically, in response to creation of a table updating function for a logging start command in the command analyzing section 18, the updating section 19 performs an updating process in which the first to the third control information included in the table updating function are added to the logging control table 11. Conversely, in response to creation of a table updating function for a logging termination command in the command analyzing section 18, the updating section 19 carries out an updating process in which the first to the third control information included in the table updating function are deleted from the logging control table 11.

If the first to the third control information included in a table updating function for a logging start command have already been registered in the logging control table 11, the updating section 19 skips the updating process and notifies the console 20 of the skip of the updating process. In addition, if the first to the third control information included in a table updating function for a logging termination command are not registered in the logging control table 11, the updating section 19 skips the updating process and notifies the console 20 of the skip of the updating process.

The logging region 13 stores therein logging information under the control of the storage controller 17, and is realized by a storage device such as a memory.

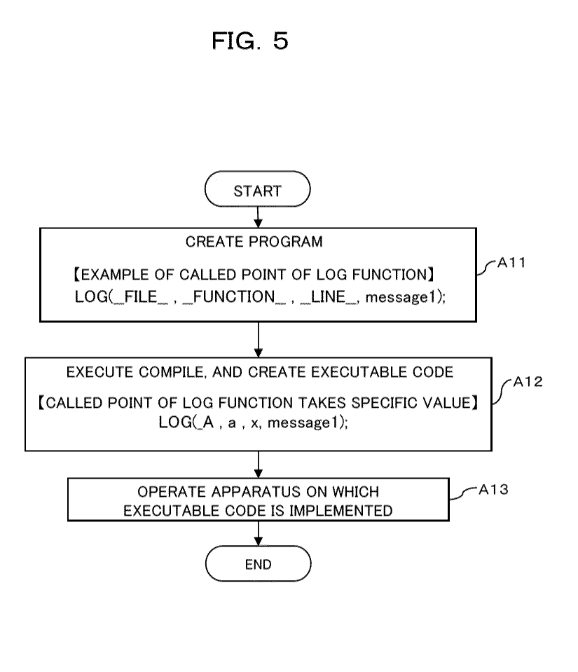

Description will now be made in relation to an example of the procedure to create the program P of the apparatus 10 for collecting logging information of the first embodiment with reference to flow diagram in FIG. 5.

The program creator creates the program P (step All). In this case, the program creator inserts a log function L′ (here, “LOG(_FILE_, _FUNCTION_, _LINE_, message 1)” abstractedly described so as to be compilable by a GNU complier at an arbitrary point (a called position) in the program P.

The computer (not illustrated) executes the compile of the program P and thereby replaces the abstracted description embedded in the log function L′ with a specific description, such as, for log function L1, “LOG(A, a, x, message 1)”, so that executable code is generated (step A12).

After the program P that has executed compile is stored in the external recording medium 21 (see FIG. 1), the apparatus 10 for collecting logging information starts execution of the program P stored in the external recording medium 21 (step A13) and terminates the procedure.

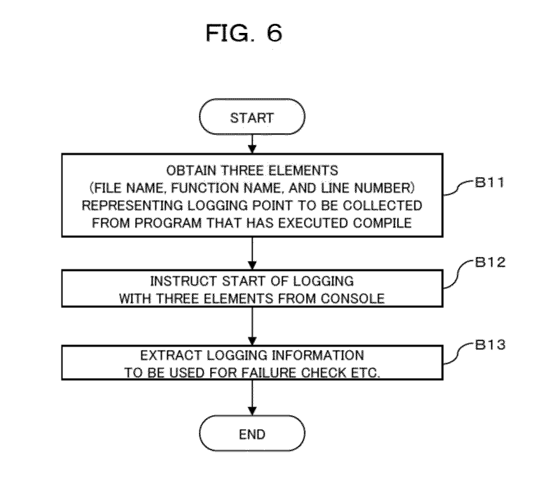

Next, description will now be made in relation to an example of procedure to instruct the start of logging in the apparatus 10 for collecting logging information of the first embodiment with reference to flow diagram in FIG. 6.

First of all, the operator obtains a logging point on the program P which point is desired to be collected, that is, a file name, a function name, and a line number through the use of the console 20 or the like (step B11).

The operator inputs into the console 20 a logging start command for a log function L that the operator wished to be collected (step B12).

Then, during the execution of the program P, the logging collecting process is called each time a log function L is executed, and the processor 12 sequentially stores logging information associated with a log function L determined to be collected into the logging region 13. The operator extracts logging information from the logging region 13, uses the extracted logging information for failure check or others (step B13), and finally terminates the procedure.

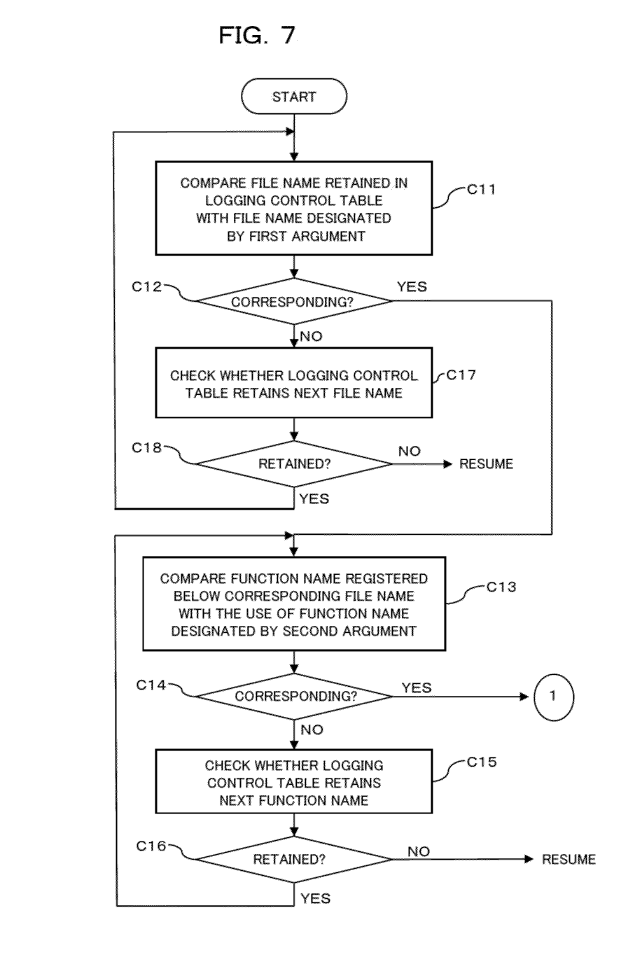

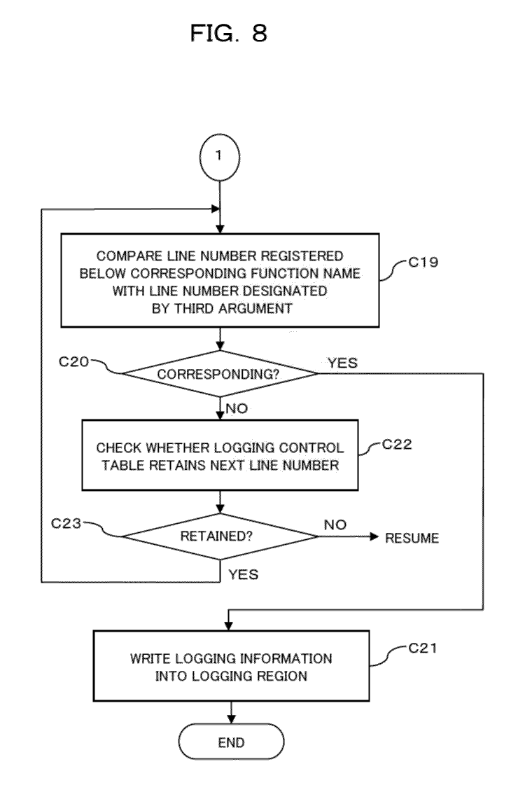

Description will now be made in relation to an example of a procedure to collect logging information in the apparatus 10 for collecting logging information having the above configuration with reference to flow diagrams of FIGS. 7 and 8.

When a log function L executed during the execution of the program P calls a logging collecting process, the obtaining section 14 obtains the first argument (file name), the second argument (function name), and the third argument (line number) which are embedded in the log function L that has called the logging collecting process.

The judging section 15 selects a piece of first control information, i.e., the file name “A” in the example of FIG. 3, among a number of pieces of first control information registered in the logging control table 11, and compares the selected piece of first control information with the first argument obtained by the obtaining section 14 (step C11).

The judging section 15 judges whether or not the first argument obtained by the obtaining section 14 corresponds to the selected piece of the first control information (step C12).

If the result of the judgment is positive (Yes route in step C12), the judging section 15 selects one piece, i.e., the function name “a” below the file name “A” in the example of FIG. 3, from pieces of the second control information registered in the logging control table 11 below the piece of the first control information, which has matched the first argument, and compares the selected piece of the second control information with the second argument obtained by the obtaining section 14 (step C13).

The judging section 15 judges whether or not the second argument obtained by the obtaining section 14 corresponds to the selected piece of the second control information (step C14).

If the result of the judgment is positive (“YES” route in step C14), the procedure moves to the flow diagram depicted in FIG. 8 (see reference number “1” in FIG. 7).

Conversely, the result of the judgment is negative (“NO” route in step C14), the judging section 15 checks whether the logging control table 11 registers therein the next piece of the second control information, for example a function name which is registered below the file name “A” other than the function name “a” and which has not been selected by the judging section 15 (step C15).

If the result of the check is positive (“YES” route in step C16), the judging section 15 selects the function name registered next and returns to step C13.

On the other hand, if the result of the check is negative (“NO” route in step C16), the processor 12 does not collect logging information and terminates the logging collecting process. After that, the processor 12 carries out a returning process to resume the execution of the program P and terminates the procedure.

If the result of the judgment in step C12 is negative (“NO” route in step C12), the judging section 15 checks whether or not the logging control table 11 has registered therein a next piece of first control information, i.e., a file name “B” different from the file name “A” in the example of FIG. 3 and which has not been selected by the judging section 15 (step C17).

If the result of the check is positive (“YES” route in step C18), the judging section 15 selects the file name registered next and returns to step C11.

On the other hand, if the result of the check is negative (“NO” rote in step C18), the processor 12 does not collect logging information and terminates the logging collecting process. After that, the processor 12 carries out a returning process to resume the execution of the program P and terminates the procedure.

If the result of judgment in step C14 of FIG. 7 is positive (“YES” route in step C14), the procedure moves to the flow of FIG. 8, where the judging section 15 selects one from pieces of third information registered below the piece of second control information matched the second argument in the logging control table 11, i.e., the line number “x” below the function name “a” in the example of FIG. 3, and compare the selected piece of third control information with the third argument obtained by the obtaining section 14 (step C19).

The judging section 15 judges whether or not the third argument obtained by the obtaining section 14 corresponds to the selected piece of the third control information (step C20).

If the result of the judgment is positive (“YES” route in step C20), the judging section 15 judges the logging information in relation to the log function L obtained by the obtaining section 14 to be collected. Therefore, after the creating section 16 has created the logging information, the storage controller 17 writes the logging information created by the creating section 16 into the logging region 13 (step C21), and then terminates the procedure.

On the other hand, if the result of the judgment is negative (“NO” route in step C20), the judging section 15 checks whether or not the logging control table 11 has registered therein the next piece of the third control information, for example, a line number which is below the function name “a”, which is different from the line number “x”, and which has not been selected by the judging section 15 (step C22).

If the result of the check is positive (“YES” route in step C23), the judging section 15 selects the piece of the third control information registered next and returns to step C19.

On the contrary, if the result of the check is negative (“NO” route in step C23), the processor 12 does not collect logging information and terminates the logging collecting process. After that, the processor 12 carries out a returning process to resume the execution of the program P and terminates the procedure.

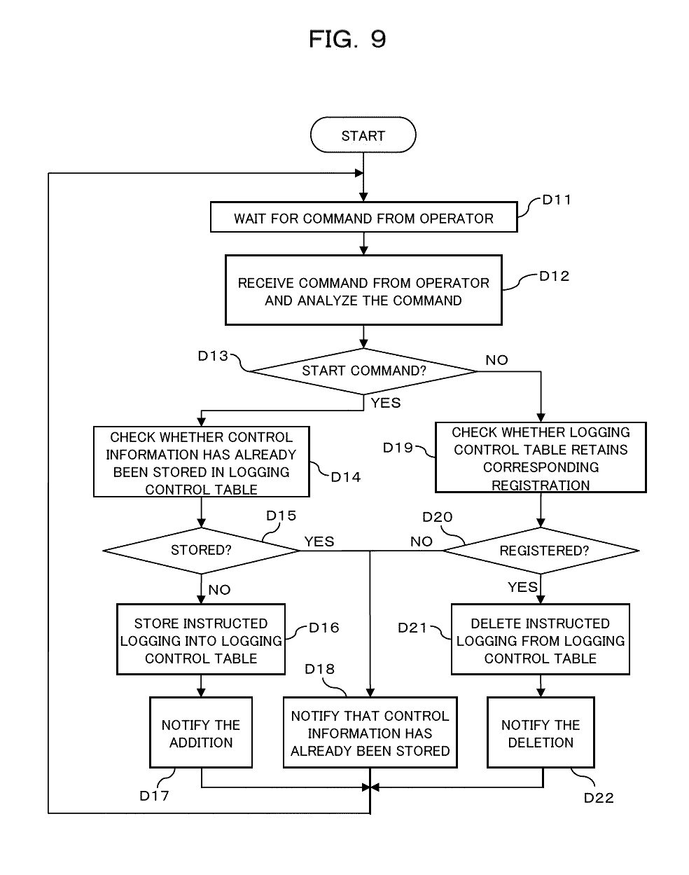

Next, description will now be made in relation to an example of a procedure to update the logging control table 11 in the apparatus 10 for collecting logging information of the first embodiment having the configuration described above with reference to the flow diagram of FIG. 9.

The command analyzing section 18 waits for command information from the operator (step D11). Upon the operator inputs command information into the console 20, the command analyzing section 18 receives the input command information from the console 20, and analyzes the command information to thereby create a table updating function (step D12).

After the creation of the table updating function by the command analyzing section 18, the updating section 19 judges whether the created table updating function is for a logging start command or for a logging termination command (step D13).

If the result of the judgment concludes that the table updating function is for a logging start command (“YES” route in step D13), the updating section 19 checks whether or not the first through the third control information included in the table updating function for a logging start command have already been registered in the logging control table 11 (step D14).

If the result of the check is negative (“NO” route in step D15), the updating section 19 adds the first through the third control information included in the table updating function into the logging control table 11 (step D16), notifies the console 20 of the addition (step D17), and then returns to step D11.

On the other hand, if the result of the check is positive (“YES” route in step D15), the updating section 19 does not updating the logging control table 11, notifies the console 20 that the logging control table 11 has not been updated (step D18), and returns to step D11.

If the result of the judgment concludes that the table updating function is for a logging termination command (“NO” route in step D13), the updating section 19 checks whether or not the first through the third control information included in the table updating function for a logging termination command have already been stored in the logging control table 11 (step D19).

If the result of the check on the table updating function for a logging termination command is positive (“YES” route in step D20), the updating section 19 deletes the first through the third control information included in the table updating function from the logging control table 11 (step D21). After that, the updating section 19 notifies the console 20 of the deletion (step D22), and returns to step D11.

If the result of the check on the table updating function for a logging termination command is negative (“NO” route in step D20), the updating section 19 does not update the logging control table 11, notifies the console 20 that the logging control table 11 has not been updated (step D18), and returns to step D11.

As described above, the apparatus 10 for collecting logging information of the first embodiment does not embed unique information into a log function L, but does embed, in the log function L, the position information indicating the position of the log function L on the program P which information takes the form of the file name (first argument), the function name (second argument) and the line number (third argument). With this configuration, the program creator can insert into any point of the program P a log function L′ which is abstractedly described so as to be compilable by a GNU compiler. Therefore, even a log function L′ is moved to another point on the program P in creation of the program P, it is possible to eliminate the requirement for change the arguments embedded in the log function L′. Accordingly, the program creator can easily insert a log function L′ abstractedly described into the program P regardless of the specific values of the arguments.

Even if the program P has a large number of log functions L as included in a large-scale project or an open source, each log function L on the program P can be easily specified by embedding in the log function L the position information, i.e., the file name (first argument), the function name (second argument) and the line number (third argument), representing the position of the log function L on the program P. That eliminates the requirement of separately management of a vast amount of unique information to specify each log function L. Accordingly, when the apparatus 10 for collecting logging information dynamically makes a judgment on each of the log functions L calling logging collecting processes as to whether or not the logging information associated with the log function L is to be collected, the log function L calling the logging collecting process is easily specified and only required logging information can be selected and collected. As a result, a possible problem can be solved at an early stage by failure check and other measurement.

### (2) Others

The present invention should by no means be limited to the foregoing embodiment and various modification and alternation can be suggested without departing from the gist of the present invention.

For example, description of the first embodiment has been made on assumption that a log function L′ is abstractedly described so as to be compilable by a GNU compiler. However, the present invention is not limited to this. Alternatively, a log function may be abstractedly described so as to be compilable by any of the known compilers. In addition, specific position information may be embedded into a log function.

In the first embodiment, the position information in the form of the arguments of a log function L represents the file name, the function name, and the line number. However, the position information is not limited to the above. Alternatively, if the program P does not define files and functions inserted therein, the position information may be the line number of a log function on the program P. Further, if the program P does not define functions inserted therein, the position information may be the file name of a file in which the log function L is inserted and the line number of the log function on the file.

Further, in the first embodiment, the creating section 16 creates logging information that the judging section 15 has judged to be collected. However, the creation of logging information is not limited to this. Alternatively, the creating section 16 may create logging information for all the log functions L obtained by the obtaining section 14. In this case, the storage controller 17 may select logging information judged by the judging section 15 to be collected among the entire logging information created by the creating section 16, and may store the selected logging information into the logging region 13.

In the first embodiment, command information including a file name, a function name, and a line number is inputted along with commands “log on” and “log off” respectively indicating a logging start command and a logging termination command into the console 20. However, the input manner is not limited to this. Alternatively, command information may be inputted by means of, for example, a Graphical User Interface (GUI).

The processor 12 executes the logging information collecting program and thereby functions as the obtaining section 14, the judging section 15, the creating section 16, the storage controller 17, the command analyzing section 18, and the updating section 19.

The logging information collecting program to realize the functions of the obtaining section 14, the judging section 15, the creating section 16, the storage controller 17, the command analyzing section 18, and the updating section 19 is provided in the form of being stored in a computer-readable recording medium, such as a flexible disk, a CD (e.g., CD-ROM, CD-R, CD-RW), a DVD (e.g., DVD-ROM, DVD-RAM, DVD-R, DVD+R, DVD-RW, DVD+RW, HD-DVD, Blu-ray disc), a magnetic disk, an optical disk, or a magneto-optical disk or a semiconductor storage device. Further, a computer reads the program from the recording medium and sends the program to an internal or external memory to store for use. Further alternatively, the program may be recorded in a memory device (a recording medium), such as a magnetic disk, an optical disk a magneto-optical disk or a semiconductor storage device, and is provided to a computer from the memory device through a communication path.

In order to realize the functions of the obtaining section 14, the judging section 15, the creating section 16, the storage controller 17, the command analyzing section 18, and the updating section 19, a microprocessor of the computer executes the program stored in an internal memory. At that time, the execution may be carried out by the computer reading the program stored in a recording medium.

In the first embodiment, a computer is a concept of a combination of hardware and an OS and means hardware which operates under control of the OS. Otherwise, if an application program operates hardware independently of an OS, the hardware corresponds to the computer. Hardware includes at least a microprocessor such as a CPU and means to read a computer program recorded in a recording medium. In the first embodiment, the apparatus 10 for collecting logging information serves to function as a computer.

The recording medium used in the first embodiment may be various computer-readable recording media such as an IC card, a ROM cartridge, a magnetic tape, a punch card, an internal storage unit (RAM or ROM) for a computer, an external storage unit, or a printing matter on which codes, such as bar codes, are printed, in addition to a flexible disk, a CD, a DVD, a magnetic disk, an optical disk and a magnet-optical disk listed above.

Even if the program has a large number of log functions, the technology of the disclosure can easily specify each log function without managing a vast amount of unique data to specify the log functions.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions have been described in detail, it should be understood that the various changes, substitutions, and alterations could be made hereto without departing from the spirit and scope of the invention.

What is claimed is:

1. An apparatus for collecting logging information in relation to a log function inserted into a program, said apparatus comprising:
a control table that retains control information in relation to specification information to specify the log function;
an obtaining section that obtains the specification information embedded in the log function when the log function is executed;
a judging section that judges, on the basis of the control information retained in said control table and the specification information obtained by said obtaining section, whether or not the logging information associated with the specification information is to be collected; and
a storage controller that stores, if the result of the judging by said judging section is positive, the logging information into a memory,
the specification information comprising position information of the log function in the program.

2. An apparatus according to claim 1, the position information comprising the line number of the log function in the program.

3. An apparatus according to claim 1, the position information including a name of a file in which the log function is embedded and which is included in the program; and a line number of the log function in the file.

4. An apparatus according to claim 1, the position information including a name of a file in which the log function is embedded and which is included in the program; a name of a function in which the log function is embedded and which is included in the file; and a line number of the log function in the function.

5. An apparatus according to claim 1, the result of the judging by said judging section being positive when the specification information obtained by said obtaining section is included in the control information retained in said control table.

6. An apparatus according to claim 1, further comprising an updating section that updates the control table.

7. A method for collecting logging information in relation to a log function inserted into a program, said method comprising:
(a) obtaining specification information embedded in the log function when the log function is executed;
(b) judging, on the basis of control information in relation to the specification information retained in a control table and the obtained specification information, whether or not the logging information associated with the specification information is to be collected; and
(c) storing, if the result of said judging is positive, the logging information into a memory,
the specification information including position information of the log function in the program.

8. A method according to claim 7, the position information including a line number of the log function in the program.

9. A method according to claim 7, the position information including a name of a file in which the log function is embedded and which is included in the program; and a line number of the log function in the file.

10. A method according to claim 7, the position information including a name of a file in which the log function is embedded and which is included in the program; a name of a function in which the log function is embedded and which is included in the file; and a line number of the log function in the function.

11. A method according to claim 7, wherein the result of said judging being positive when the obtained specification information is included in the control information retained in the control table.

12. A method according to claim 7, further comprising updating the control table.

13. A computer-readable recording medium in which a logging information collecting program for collecting logging information in relation to a log function inserted into a program, said logging information collecting program instructing a computer to function as:
an obtaining section obtaining specification information embedded in the log function when the log function is executed;
a judging section judging, on the basis of control information in relation to the specification information retained in a control table and the specification information obtained by said obtaining section, whether or not the logging information associated with the specification information is to be collected; and
a storage controller storing, if the result of the judging by said judging section is positive, the logging information into a memory,
the specification information comprising position information of the log function in the program.

14. A computer-readable recording medium according to claim 13, the position information comprising the line number of the log function in the program.

15. A computer-readable recording medium according to claim 13, the position information comprising: the file name of a file in which the log function is embedded and which is included in the program; and the line number of the log function in the file.

16. A computer-readable recording medium according to claim 13, the position information comprising: the file name of a file in which the log function is embedded and which is included in the program; the function name of a function in which the log function is embedded and which is included in the file; and the line number of the log function in the function.

17. A computer-readable recording medium according to claim 13, the result of the judging by said judging section is positive when the specification information obtained by said section of obtaining is included in the control information retained in the control table.

18. A computer-readable recording medium according to claim 7, said logging information collecting program instructing the computer to further function as an updating section updating the control table.
